(19) United States
(12) Patent Application Publication
(10) Pub. No.: US 2024/0176996 A1
(43) Pub. Date: May 30, 2024

(54) SYSTEM AND METHOD ARRANGED TO CUSTOMIZE ARTIFICIAL NEURAL NETWORK

(71) Applicant: GENENET TECHNOLOGY (UK) LIMITED, London (GB)

(72) Inventors: Chi U SEAK, London (GB); Chon In CHEONG, London (GB); Ming-Tsung WU, London (GB)

(21) Appl. No.: 18/058,918

(22) Filed: Nov. 28, 2022

(51) Int. Cl. G06N 3/048; G06N 3/10

(52) U.S. Cl. CPC G06N 3/048; G06N 3/105

(57) ABSTRACT

Disclosed is a system arranged to customize an Artificial Neural Network (ANN) comprising an ANN architecture, comprising an input layer comprising at least one node, at least one hidden layer comprising at least one node, and an output layer comprising at least one node, wherein the input layer and the at least one hidden layer are connected by edges, and the at least one hidden layer and the output layer are connected by edges, wherein each node comprises an activation function; a graphical user interface arranged to receive user input, the user input comprising indication on how to customize the number of hidden layers; indication on how to customize the number of nodes for each of the hidden layers; indication on how to customize the at least one activation function for one or more of the nodes; and a processor configured to provide the ANN based on the received indications of customisation; and simulate the ANN with a dataset, wherein the output of the simulation defines a measure of a benchmark of ANN.

### FIELD OF THE INVENTION

This invention relates to artificial neural networks. In particular, though not exclusively, this invention relates to a system arranged to customize an artificial neural network and a method arranged to customize an artificial neural network.

### BACKGROUND

Generally, artificial neural network (ANN) models are inspired by neuroscience models which replicate the neural activity of a human brain. The fundamental unit of the ANN model is a node, where the working of the node is controlled by parameters such as activation functions and weights that affect the training dynamics and performance of the ANN. Due to the nature of biological response characteristics, the most commonly used activation functions follow either s-shaped or linear-shaped functions with a negative region set to 0 or a small negative value, such as, sigmoid, a hyperbolic tangent function (Tanh), rectified linear unit (ReLU), leaky ReLU, and the like. The ANN research field has continuously been searching for improvements in the design of both the activation functions and the weights.

Existing techniques of training and generating an ANN are not user friendly. There is often no way to customize the ANN based on user-defined activation functions or weight parameters, making the whole process cumbersome and resource intensive. Moreover, the user is not able to implement the generated ANN for domain-specific problems as the user is not able to efficiently compare the output of the ANN with datasets of the user's choice.

Therefore, in light of the foregoing discussion, there exists a need for a technique for customized construction, training, and evaluation of one or more artificial neural networks according to user-defined instructions.

### SUMMARY OF THE INVENTION

A first aspect of the invention provides a system arranged to customize an Artificial Neural Network (ANN) comprising: an ANN architecture, comprising: an input layer comprising at least one node, at least one hidden layer comprising at least one node, and an output layer comprising at least one node, wherein the input layer and the at least one hidden layer are connected by edges, and the at least one hidden layer and the output layer are connected by edges, wherein each node comprises an activation function; a graphical user interface arranged to receive user input, the user input comprising: indication on how to customize the number of hidden layers; indication on how to customize the number of nodes for each of the hidden layers; indication on how to customize at least one activation function for one or more of the nodes; and a processor configured to: provide the ANN based on the received indications of customisation; and simulate the ANN with a dataset, wherein the output of the simulation defines a measure of the benchmark of the ANN.

Suitably, the system provides complete flexibility in all aspects of building an ANN model. The system allows for customization of features of the ANN such as the number of hidden layers, the number of nodes within each layer, the initial shapes of the activation functions. The system may provide an option to evolve the shapes of the activation functions through back-propagation. The system may also suggest the combinations of features that provide the desirable results. Moreover, the system of the present disclosure provides a user-friendly platform to incorporate the user-defined activation functions (i.e., sigmoid, tanh, ReLu) for generating the ANN.

Furthermore, allowing the user to simulate the ANN by extracting files from a database of the user's choice, enables the user to implement the generated ANN model across a number of fields. Thus, the user now has the flexibility to customize the activation functions and other user-based indications according to the results of the simulation of the generated ANN in a more efficient manner that allows the user to implement the generated ANN to a field of their choice.

The term “Artificial Neural Network (ANN)” as used herein refers to a computer-implemented system that replicates the working of a biological neural network, so the computer is capable of learning and making decisions on its own, like a human. Subsequently, customization of the ANN involves customizing various elements present in an ANN architecture. The ANN architecture comprises three types of layers, an input layer, at least one hidden layer, and an output layer, where each of the layers comprises at least one node. Moreover, the input layer is connected with the at least one hidden layer via edges. The at least one hidden layer is connected with the output layer via edges.

The term “node” as used herein refers to a computational unit present in the ANN which replicates the working of a neuron, where each node is present in a layer. Herein, the node is configured to receive input data from the at least one node of a consecutively preceding layer and pass on output data to the at least one node of the consecutively following layer. Subsequently, the node of one layer connects with the node of the consecutive following layer or the consecutively preceding layer by edges. The term “edge” as used herein refers to a representation of weights and biases for linear transformations in between layers. The term “weight” as used herein refers to numerical parameters that determine how strongly the node will affect the other nodes with which the node connects.

In an exemplary embodiment, multiple nodes of a first hidden layer may connect to a single node of a second hidden layer that consecutively follows the first hidden layer. Subsequently, the single node of the second hidden layer receives the sum of the respective products of the input data and the weight for each respective node of the first hidden layer that connects with the single node of the second hidden layer.

Herein, the sum of the respective products of the input data and the weight for each respective node of a certain layer that connects to another node of the consecutive following layer is termed as “transfer function”. Subsequently, the node thus receives the inputs and the weights from the at least one node of a consecutively preceding layer in the form of the transfer function, where the value of the transfer function is passed on to the activation function of the node. The term “activation function” as used herein refers to a mathematical function that determines whether a node is to be activated i.e., to connect with a node of the consecutively following layer or not. Herein, the activation function for the node generates a certain value which is then compared to a predefined threshold value and if the certain value is greater than the predefined threshold value, then the node is activated to connect with the at least one node of the consecutive following node.

In an embodiment, the activation function of the input layer differs from the activation function of the at least one hidden layer, and/or the activation function of the at least one hidden layer differs from the activation function of the output layer, and/or the activation function of the input layer differs from the activation function of the output layer.

In another embodiment, the activation function of the input layer, the activation function of the at least one hidden layer, and the activation function of the output layer are all different. Thus, there exists flexibility in selecting the activation function for different nodes of different layers within the ANN architecture.

Alternatively, the activation function of a first node in the at least one hidden layer differs from the activation function of a second node in the at least one hidden layer. Hence, there are a vast number of combinations in which the different activation functions for each respective node may be selected for achieving optimized results from the ANN.

Moreover, to customize the ANN, the system receives user input via a graphical user interface. The term “user input” as used herein refers to an input received from the user in terms of an indication of specific parameters regarding how the user is willing to customize the architecture of the ANN to get an optimum desired result as the output of the ANN. Herein, the indications that the user provides comprises customizing the number of hidden layers, the number of nodes for each of the hidden layers, at least one activation function for one or more of the nodes. Herein, different combinations of one or more indications that are provided as user input are referred to as “regulators” in the present disclosure. Subsequently, the processor provides the ANN that is modelled on the received indications of customization.

In an embodiment, the user input further comprises an indication of an estimation of an activation function, and the processor is further configured to generate the at least one activation function based on a transformation of the estimation. In this regard, the indication of the estimation may refer to a numerical value with which the input data is compared to generate the at least one activation function and decide whether the particular node will be activated or not.

In an embodiment, the at least one activation function is a gaussian function, sigmoidal function, reLu function, tanh function, a rectified linear function, or a swish function.

In another embodiment, the user input further comprises an indication on how to customize the weight of at least one of the edges. In this regard, customizing the weight of at least one of the edges allows the user to control the impact of one layer in the ANN over another layer in the ANN.

Furthermore, the processor is configured to simulate the ANN with a dataset. Herein, the dataset may be in the form of experimental data. Alternatively, the dataset may be selected from a publicly available database or library. Herein, simulating the ANN with the dataset allows the user to compare the results of the customized ANN with a desired result related to a specific domain that the user wants. utilize the customized ANN corresponding to a specific domain. Moreover, simulating the ANN with the dataset which includes experimental data allows the customized ANN to be useful in predicting data that is relative to the specific domain. In an exemplary scenario, the user may simulate the ANN with gene expression data for further gene prediction. Subsequently, the output of the simulation defines a measure of a benchmark of the ANN. The term “measure of a benchmark” as used herein refers to evaluating the ANN on parameters such as accuracy and/or utility of the ANN with respect to the desired result. In an exemplary scenario, the measure of the benchmark of the ANN may refer to the optimum utility and precision of the ANN for gene prediction, where the ANN is simulated with the gene expression data.

In an embodiment, based on the results of the simulation, the user may not be satisfied with the measure of the benchmark of the ANN and accordingly choose to further customize the indications (e.g., weights or activation functions) that were previously given to get a more desired measure of the benchmark of the ANN.

In an embodiment, the dataset corresponds to the measurement of at least one biological interaction. For example, the dataset may correspond to the measurement of gene expression data of a certain gene as the at least one biological interaction.

In an embodiment, the processor is further configured to pre-process the dataset prior to simulating the ANN. In this regard, the pre-processing of the dataset prior to simulating the ANN allows to make the dataset more suitable and compatible for simulating the ANN and provide the necessary results.

In an embodiment, the processor is further configured to generate at least one activation function based on the dataset. In this regard, the least one activation is generated with respect to the specific domain of the dataset. Thus, using the generated at least one activation function, the system is able to customize the ANN with respect to the specific domain that is intended by the user, hence enhancing the overall utility of the system.

In an embodiment, the graphical user interface is arranged to receive additional user input of the pre-trained ANN, the additional user input comprising the data of the architecture of the ANN, comprising:
at least one activation function, the number of hidden layers, the number of nodes for each of the hidden layers; and/or the weight of all nodes.

In this regard, the user can directly provide the pre-trained ANN as the additional user input along with the data of the architecture of the ANN, thus allowing the user to subsequently simulate the provided pre-trained ANN with the dataset to achieve the desired results.

In an embodiment, the system further comprises a database configured to store at least one of:
the dataset, the number of layers, the number of nodes, the weight of the edges, the at least one activation function, the ANN, at least one layer of the ANN, the output of the run.

In this regard, the database allows the user to keep track of all the customizations previously used, and a record of the results of the simulations previously run over the customized ANN. Thus, the user can perform a detailed analysis based on the data that is stored in the database. Moreover, the user may share the previous customizations and results with new users via the data that is stored in the database.

A second aspect of the invention provides a method arranged to customize an Artificial Neural Network (ANN), comprising providing an ANN architecture, comprising an input layer comprising at least one node, at least one hidden layer comprising at least one node, and an output layer comprising at least one node, wherein the input layer and the at least one hidden layer are connected by edges, and the at least one hidden layer and the output layer are connected by edges, wherein each node comprises an activation function; providing a graphical user interface arranged to receive user input, the user input comprising indication on how to customize the number of hidden layers; indication on how to customize the number of nodes for each of the hidden layers; indication on how to customize at least one activation function for one or more of the nodes; and providing a processor configured to provide the ANN based on the received indications of customisation; and simulate the ANN with a dataset, wherein the output of the simulation defines a measure of a benchmark of the ANN.

In an embodiment, the activation function of the input layer differs from the activation function of the at least one hidden layer, and/or the activation function of the at least one hidden layer differs from the activation function of the output layer, and/or the activation function of the input layer differs from the activation function of the output layer.

In an embodiment, the activation function of the input layer, the activation function of the at least one hidden layer, and the activation function of the output layer are all different.

In an embodiment, the activation function of a first node in the at least one hidden layer differs from the activation function of a second node in the at least one hidden layer.

In an embodiment, the processor is further configured to generate at least one activation function based on the dataset.

In an embodiment, the user input further comprises an indication of an estimation of an activation function, and the processor is further configured to generate at least one of the activation functions based on a transformation of the estimation.

In an embodiment, the at least one activation function is a gaussian function, sigmoidal function, reLu function, tanh function, a rectified linear function, or a swish function.

In an embodiment, the user input further comprises an indication on how to customize a weight of at least one of the edges.

In an embodiment, the processor is further configured to pre-process the dataset prior to simulating the ANN.

In an embodiment, the method further comprises receiving further user input of the pre-trained ANN, the further user input comprising the data of the architecture of ANN, comprising:
at least one activation function, the number of hidden layers, the number of nodes for each of the hidden layers, and/or the weight of all nodes.

In an embodiment, the method further comprises storing in one or more databases at least one of the dataset, the number of layers for the ANN, the number of nodes for one or more of the layers, the at least one activation function, the ANN, at least one layer of the ANN, the output of the run.

In an embodiment, the dataset corresponds to the measurement of at least one biological interaction.

A third aspect of the invention provides a computer program comprising instructions which, when the program is executed by a computer, cause the computer to carry out the steps of the aforementioned method.

Throughout the description and claims of this specification, the words “comprise” and “contain” and variations of the words, for example, “comprising” and “comprises”, mean “including but not limited to”, and do not exclude other components, integers, or steps. Moreover, the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Within the scope of this application, it is expressly intended that the various aspects, embodiments, examples, and alternatives set out in the preceding paragraphs, in the claims and/or in the following description and drawings, and in particular, the individual features thereof may be taken independently or in any combination. That is, all embodiments and/or features of any embodiment can be combined in any way and/or combination, unless such features are incompatible.

### BRIEF DESCRIPTION OF THE DRAWINGS

One or more embodiments of the invention will now be described, by way of example only, with reference to the accompanying drawings, in which:

FIG. 1 is a block diagram of a system arranged to customize an Artificial Neural Network (ANN), in accordance with an embodiment of the present disclosure;

FIG. 2 illustrates a flowchart of a method FIG. 2 illustrates a flowchart of a method arranged to customize an Artificial Neural Network (ANN), in accordance with an embodiment, in accordance with an embodiment of the present disclosure;

FIG. 3 illustrates a flowchart of a method of simulation of artificial neural networks (ANNs) with combinations of user-defined activation functions, in accordance with an embodiment of the present disclosure;

FIG. 4 illustrates a flowchart of a method of an exemplary use case of customizing the ANN, in accordance with an embodiment of the present disclosure;

FIG. 5 illustrates a flowchart of a method of an example use-case scenario of using ANN with user-defined activations for genetic circuit design, in accordance with an embodiment of the present disclosure;

FIG. 6 is a block diagram of a training procedure of an ANN with user-defined activation functions, in accordance with some embodiments of the present disclosure;

FIG. 7 illustrates a flowchart of a method to show the data flow for supporting a graphical user interface, for user-defined activation functions as the backend “AI” engine, in accordance with an embodiment of the present disclosure;

FIG. 8 is a block diagram of mimic ANN training procedure, for gene expression prediction according to change of an expression level of a subset of genes, in accordance with some embodiments of the present disclosure;

FIG. 9 illustrates a flow chart of a method for gene prediction using an ANN, in accordance with an embodiment of the present disclosure;

FIG. 10 is a block diagram of implementing an ANN for gene prediction, in accordance with some embodiments of the present disclosure;

FIG. 11 illustrates a schematic illustration of graphical user interface design layout for implementing various embodiments of the present technology of the present disclosure;

FIG. 12A is a schematic illustration of a user interface view depicting a mode for data extraction, in accordance with an embodiment of the present disclosure;

FIG. 12B is a schematic illustration of a user interface view depicting a mode for data extraction, in accordance with an embodiment of the present disclosure;

FIG. 12C is a schematic illustration of a user interface view depicting a mode for data extraction, in accordance with an embodiment of the present disclosure;

FIG. 13A is a schematic illustration of an exemplary user interface view during data pre-processing, in accordance with an embodiment of the present disclosure;

FIG. 13B is a schematic illustration of an exemplary user interface view during data pre-processing, in accordance with an embodiment of the present disclosure;

FIG. 14A is a schematic illustration of an exemplary user interface view for generation of regulators, in accordance with an embodiment of the present disclosure;

FIG. 14B is a schematic illustration of an exemplary user interface view for generation of regulators, in accordance with an embodiment of the present disclosure;

FIG. 14C is a schematic illustration of an exemplary user interface view for generation of regulators, in accordance with an embodiment of the present disclosure;

FIG. 14D is a schematic illustration of an exemplary user interface view for generation of regulators, in accordance with an embodiment of the present disclosure;

FIG. 14E is a schematic illustration of an exemplary user interface view for generation of regulators, in accordance with an embodiment of the present disclosure;

FIG. 15A is a schematic illustration of an exemplary user interface view for training the neural networks, in accordance with an embodiment of the present disclosure;

FIG. 15B is a schematic illustration of an exemplary user interface view for training the neural networks, in accordance with an embodiment of the present disclosure;

FIG. 15C is a schematic illustration of an exemplary user interface view for training the neural networks, in accordance with an embodiment of the present disclosure;

FIG. 15D is a schematic illustration of an exemplary user interface view for training the neural networks, in accordance with an embodiment of the present disclosure;

FIG. 15E is a schematic illustration of an exemplary user interface view for training the neural networks, in accordance with an embodiment of the present disclosure;

FIG. 16A is a schematic illustration of a user interface view of simulation of one or more regulators associated with the one or more neural networks as a stochastic way for data prediction, in accordance with an exemplary scenario of the present disclosure;

FIG. 16B is a schematic illustration of a user interface view of simulation of one or more regulators associated with the one or more neural networks as a stochastic way for data prediction, in accordance with an exemplary scenario of the present disclosure;

FIG. 17A depicts a user interface view of a transformation record of the regulators, in accordance with an exemplary scenario of the present disclosure;

FIG. 17B depicts a user interface view of biological regulator profiles and correlations between regulators, in accordance with an exemplary scenario of the present disclosure;

FIG. 18 illustrates an example of a hardware implementation for the system of FIG. 1, in accordance with an embodiment of the present disclosure.

### DETAILED DESCRIPTION

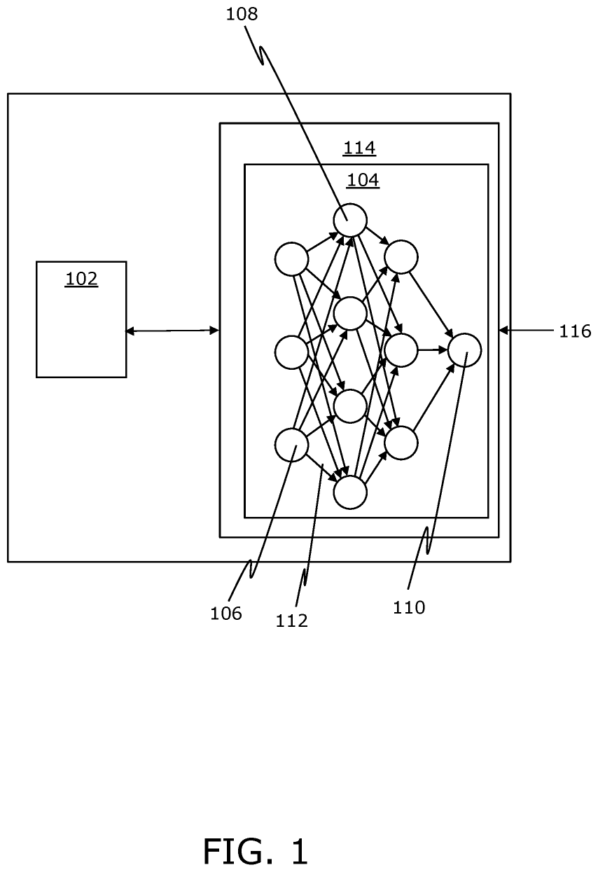

Referring to FIG. 1, shown is a block diagram of a system 100 arranged to customize an Artificial Neural Network (ANN) 104, in accordance with an embodiment of the present disclosure. Herein, the system 100 comprises an ANN architecture, comprising an input layer comprising at least one node 106, at least one hidden layer comprising at least one node 108, and an output layer comprising at least one node 110, wherein the input layer and the at least one hidden layer are connected by edges 112, and the at least one hidden layer and the output layer are connected by edges 112, wherein each node comprises an activation function. Moreover, the system 100 comprises a graphical user interface 114 arranged to receive user input 116, the user input 116 comprising indication on how to customize the number of hidden layers; indication on how to customize the number of nodes for each of the hidden layers; indication on how to customize at least one activation function for one or more of the nodes. Furthermore, the system 100 comprises a processor 102 configured to provide the ANN 104 based on the received indications of customization; and simulate the ANN 104 with a dataset, wherein the output of the simulation defines a measure of a benchmark of the ANN 104.

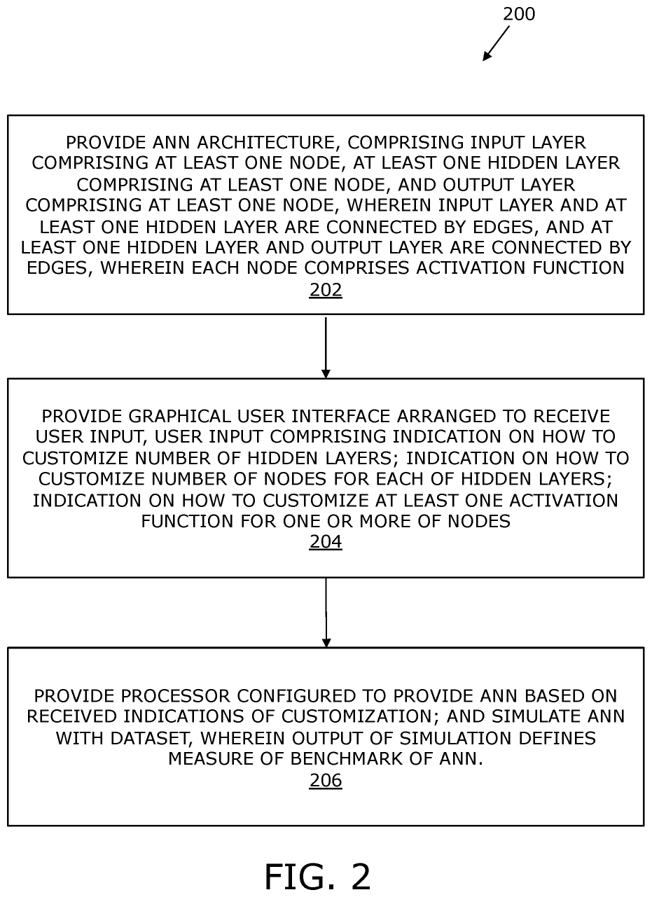

Referring to FIG. 2, shown is a flowchart of steps of a method 200 arranged to customize an Artificial Neural Network (ANN), in accordance with an embodiment of the invention. At step 202, an ANN architecture, comprising an input layer comprising at least one node, at least one hidden layer comprising at least one node, and an output layer comprising at least one node, wherein the input layer and the at least one hidden layer are connected by edges, and the at least one hidden layer and the output layer are connected by edges, wherein each node comprises an activation function is provided. At step 204, a graphical user interface arranged to receive user input is provided, the user input comprising indication on how to customize the number of hidden layers; indication on how to customize the number of nodes for each of the hidden layers; indication on how to customize at least one activation function for one or more of the nodes. At step 206, a processor configured to provide the ANN based on the received indications of customisation; and simulate the ANN with a dataset, wherein the output of the simulation defines a measure of a benchmark of the ANN is provided.

The steps 202, 204, and 206 are only illustrative and other alternatives can also be provided where one or more steps are added, one or more steps are removed, or one or more steps are provided in a different sequence without departing from the scope of the claims herein.

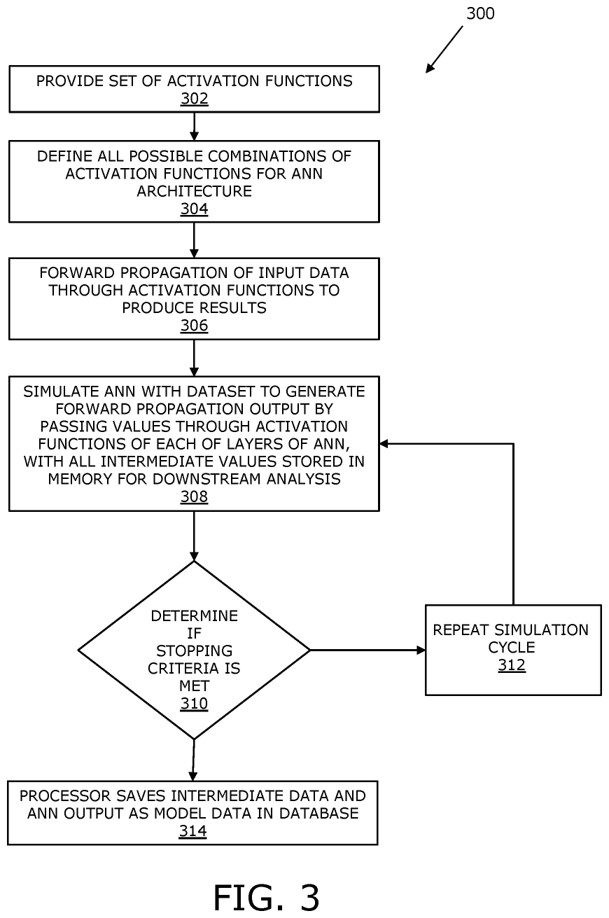

Referring to FIG. 3, shown is a flowchart of a method 300 of simulation of artificial neural networks with combinations of user-defined activation functions, in accordance with an embodiment. At step 302, a set of activation functions is provided. At step 304, all possible combinations of activation functions for an ANN architecture are defined. At step 306, input data is forward propagated through the activation functions to produce results. At step 308, the ANN is simulated to generate forward propagation output by passing values through the activation functions of each of the layers of the ANN, with all intermediate values stored in memory for downstream analysis. At step 310, it is determined whether stopping criteria are met. At step 312, if the stopping criteria are not met, a simulation cycle is repeated by repeating steps 308 to 310 by modifying the values of the activation functions. At step 314, if the stopping criteria are met, intermediate data and ANN output is saved as model data by the processor in a database.

The steps 302, 304, 306, 308, and 310 are only illustrative and other alternatives can also be provided where one or more steps are added, one or more steps are removed, or one or more steps are provided in a different sequence without departing from the scope of the claims herein.

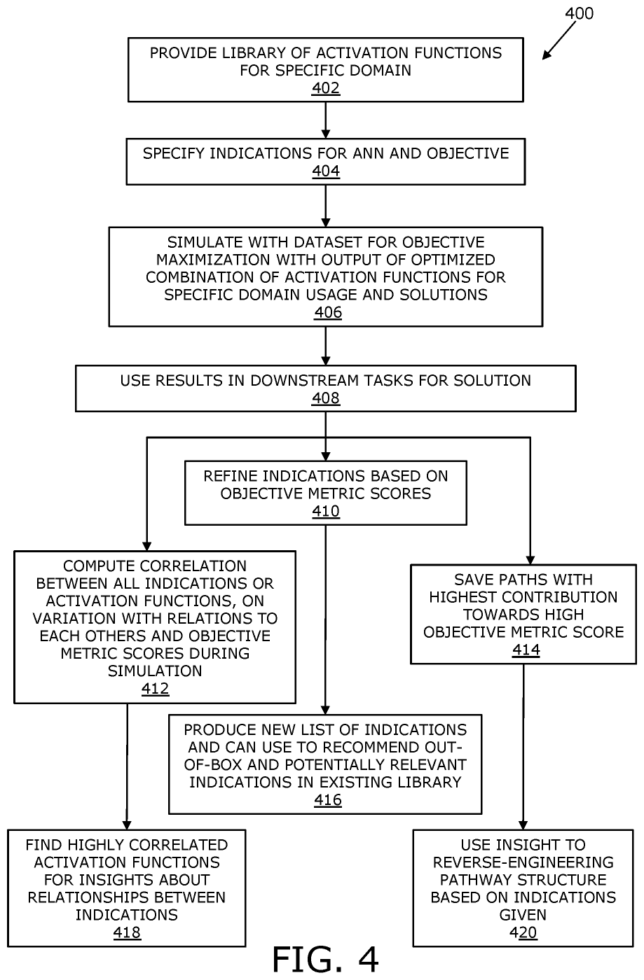

Referring to FIG. 4, shown is a flowchart of a method 400 of an exemplary use case of customizing the ANN for implementation in a specific domain, in accordance with an embodiment of the present disclosure. At step 402, a library of activation functions for the specific domain is provided. At step 404, indications for the ANN and the objective are specified. At step 406, simulation is done with the dataset for objective maximization with an output of an optimized combination of activation functions for domain usage and solutions. At step 408, the results are used in downstream tasks for a solution. At step 410, indications are refined based on objective metric scores. At step 412, a correlation between all the indications or the activation functions are computed, on variation with relations to each other and the objective metric scores during simulation. At step 414, paths with the highest contribution towards a high objective metric score are saved. At step 416, a new list of indications is produced and can be used to recommend out-of-the-box and potentially relevant indications in an existing library. At step 418, the highly correlated activation functions for insights about relationships between weights are found. At step 420, the insight to reverse-engineering pathway structure is used based on the indications given.

The steps 402, 404, 406, 408, 410, 412, 414, 416, 418, and 420 are only illustrative and other alternatives can also be provided where one or more steps are added, one or more steps are removed, or one or more steps are provided in a different sequence without departing from the scope of the claims herein.

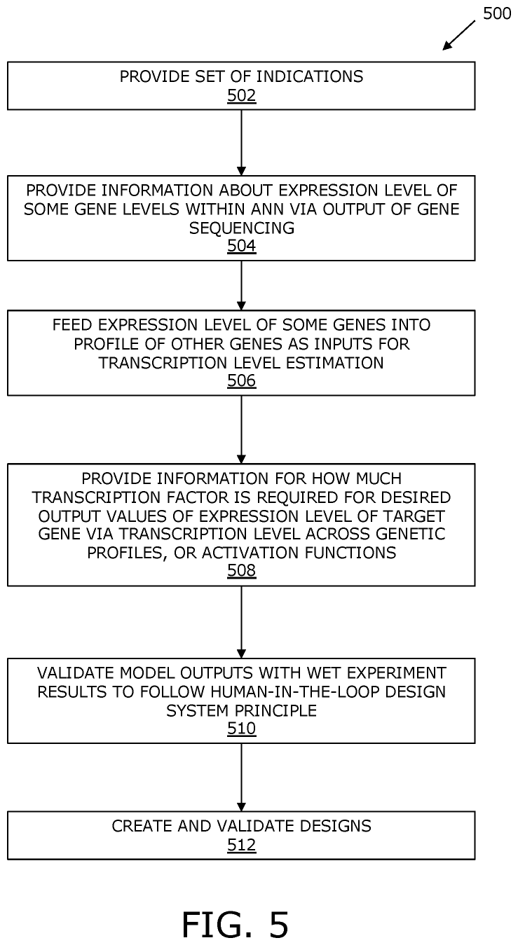

Referring to FIG. 5, shown is a flowchart of a method 500 of an example use case scenario of using ANN with user-defined activations for genetic circuit design, in accordance with an embodiment of the present disclosure. At step 502, a set of indications are provided by a user. At step 504, information about the expression level of some gene levels within the ANN is provided via the output of the gene sequencing. At step 506, the expression level of some genes is fed into the profile of other genes as inputs for transcription level estimation. At step 508, the information for how much transcription factor is required for desired output values of the expression level of a target gene is provided by the transcription level across the genetic profiles, or activation functions. At step 510, model outputs with wet experiment results are validated to follow the human-in-the-loop design system principle. At step 512, designs are created and validated.

The steps 502, 504, 506, 508, 510, and 512 are only illustrative and other alternatives can also be provided where one or more steps are added, one or more steps are removed, or one or more steps are provided in a different sequence without departing from the scope of the claims herein.

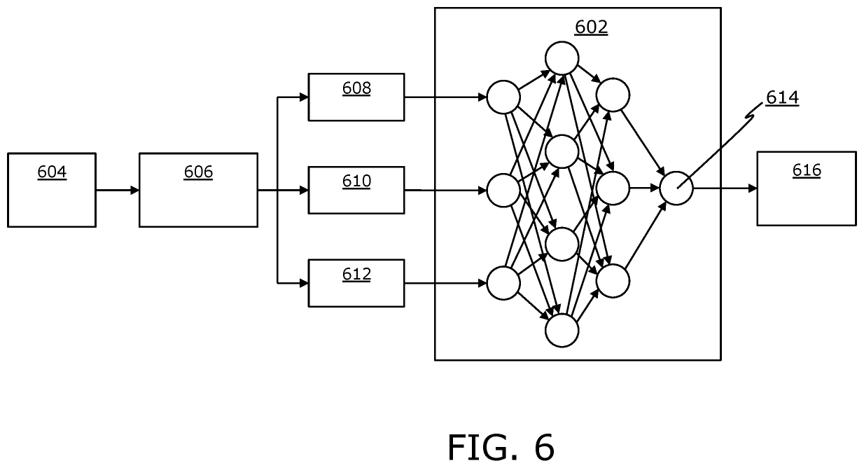

Referring to FIG. 6, shown is a block diagram of the training procedure of an ANN 602 with user-defined activation functions, in accordance with some embodiments of the present disclosure. Herein, an RNA sequence 604 is subjected to an alignment pipeline 606 (i.e., Galaxy tool). The alignment pipeline 606 performs genetic indication collection that incorporates information about biomarker selection using differential gene expression with treatment vs control. Moreover, an expression level for Gene A 608, Gene B 610, and Gene C 612 is chosen. The ANN 602 is mimicked using the expression level of Gene A 608, Gene B 610, and Gene C 612 to generate a target gene 614 having an expression value 616. In Mimic ANN 602 each of these would simulate with all the different combinations of indications in the genetic indication collection. An example of data includes a treated drug. The input (same concentration) RNA sequence (seq) can include 5 mins: RNA seq, 10 mins: RNA seq, and 15 mins: RNA seq. The target gene 614 includes, for example, a Genome wide's gene, exp data (RNA seq).

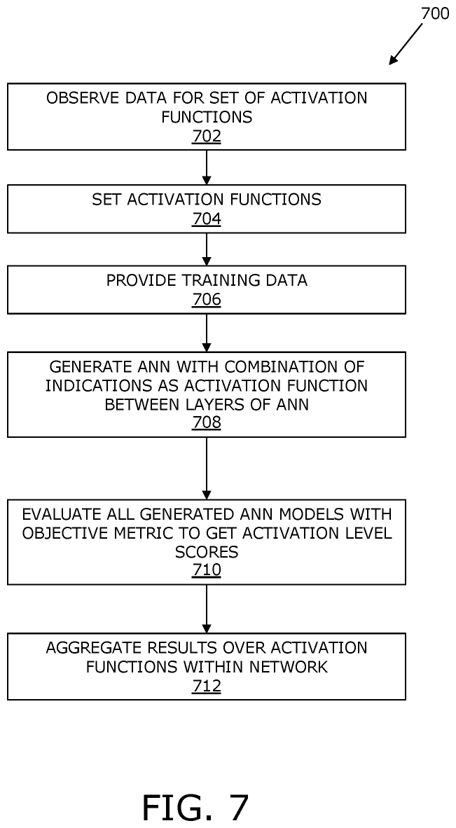

Referring to FIG. 7, shown is a flowchart of a method 700 to show the data flow for supporting a graphical user interface, with user-defined activation functions as the backend “AI” engine, in accordance with an embodiment of the present disclosure. At step 702, data for a set of activation functions is observed. At step 704, the activation functions are set. At step 706, the training data is provided. At step 708, the ANN with the combination of indications as the activation function between layers of the ANN is generated. At step 710, all the generated ANN models are evaluated with an objective metric to get activation level scores. At step 712, results over the activation functions within the network are aggregated.

The steps 702, 704, 706, 708, 710, and 712 are only illustrative and other alternatives can also be provided where one or more steps are added, one or more steps are removed, or one or more steps are provided in a different sequence without departing from the scope of the claims herein.

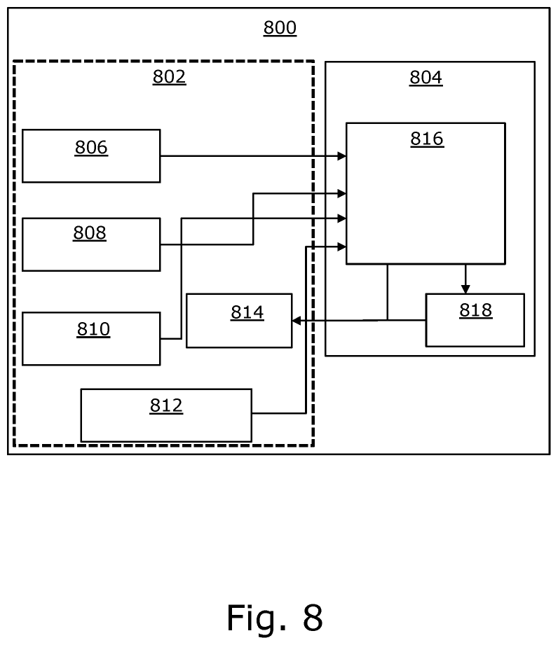

Referring to FIG. 8, shown is a block diagram of mimic ANN 800 training procedure, for gene expression prediction according to change of an expression level of a subset of genes, in accordance with some embodiments of the present disclosure. Herein, the ANN 800 consists of a client system 802 and a server system 804. The client system 802 comprises an indication library 806, an experimental data 808, user-defined parameters 810, a public RNA sequence data 812 and a visualization 814. Moreover, the server system 804 comprises a model generation system 816 and a model library 818. The user has the option to select which set of indications to use for modelling. The user chooses a labelled dataset for running the model for the combination of indications that yield the highest likelihood for the labelled results. The users can choose the model type, generic (ANN) or mimic (ANN), for comparison and experimentation benchmarking purposes. The mimic ANN 800 has an extra selection of indication sets. The number of layers and the number of nodes for each layer are totally flexible for both. The training set and the hold-out test set are separated at the beginning for a fair test score.

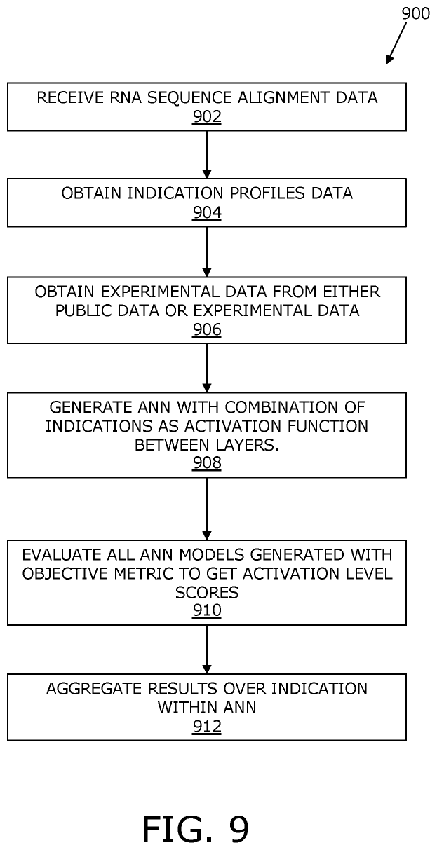

Referring to FIG. 9, shown is a flow chart of a method 900 for gene prediction using an ANN, in accordance with an embodiment of the present disclosure. At step 902, RNA sequence alignment data is received. At step 904, indication profile data is obtained. At step 906, experimental data is obtained from either public data or experimental data. At step 908, the ANN is generated with the combination of indications as the activation function between layers. At step 910, all the ANN models generated are evaluated with an objective metric to get activation level scores. At 912, results over the indication within the ANN are aggregated.

The steps 902, 904, 906, 908, 910, and 912 are only illustrative and other alternatives can also be provided where one or more steps are added, one or more steps are removed, or one or more steps are provided in a different sequence without departing from the scope of the claims herein.

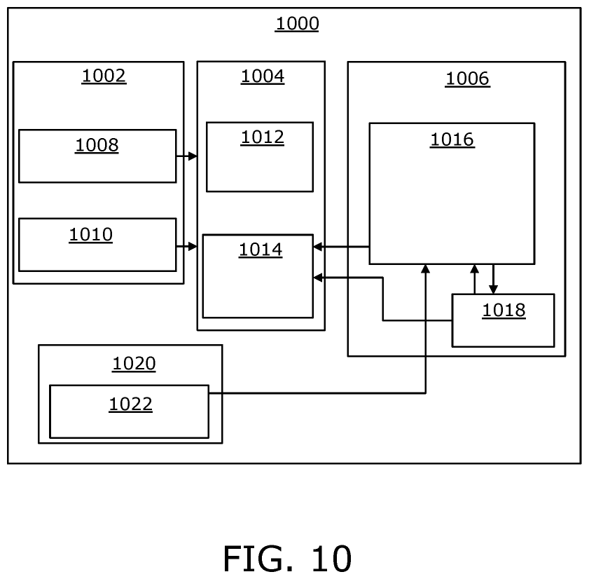

Referring to FIG. 10, shown is a block diagram of implementing an ANN 1000 for gene prediction, in accordance with some embodiments of the present disclosure. The ANN 1000 for gene prediction is configured for gene expression prediction according to the change of expression level of a subset of genes. The ANN 1000 consists of a client system 1002, an interactive layer 1004, and a server system 1006. The client system 1002 includes a gene expression library 1008 and user-defined indications 1010. The interactive layer 1004 contains an indication controller 1012 and a visualization unit 1014. The server system 1006 contains a model generation system 1016 and a model library and database 1018. The model generation system 1016 receives public RNA sequence data 1020 from public data 1022 and receives indication profiles data from either public data 1022 or experimental data from model library and database 1018.

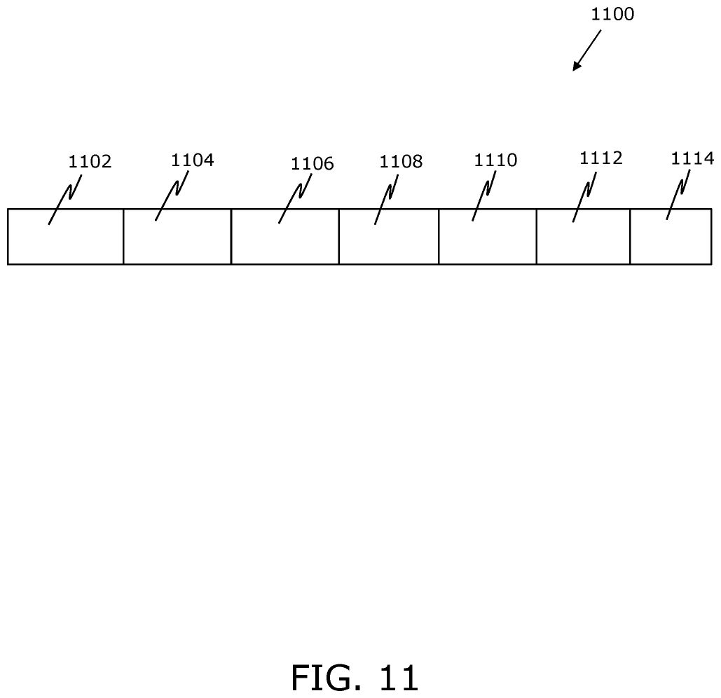

Referring to FIG. 11, shown is a schematic illustration of a design of a navigation bar 1100 for a graphical user interface, in accordance with an exemplary scenario of the present disclosure. For streamlining experiments with the simulation of results, machine learning applications, and comparison of results (subject to adjustment based on requirements), the navigation bar 1100 includes a user-defined activation section 1102 including multiple tabs including, a “Data Extraction” tab 1104, a “Data Pre-processing” tab 1106, an “Activation designs” tab 1108, a “Train Neural Networks” tab 1110, a “Genetic Circuit Design” tab 1112, and a “Gene Expression Prediction” tab 1114.

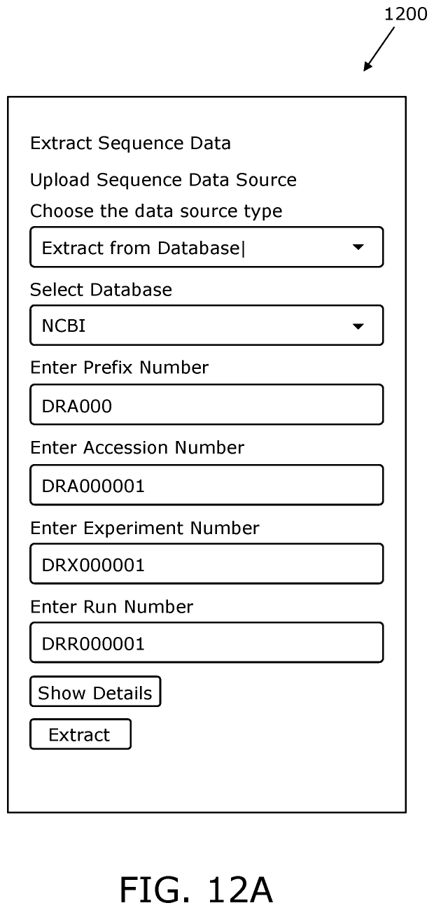

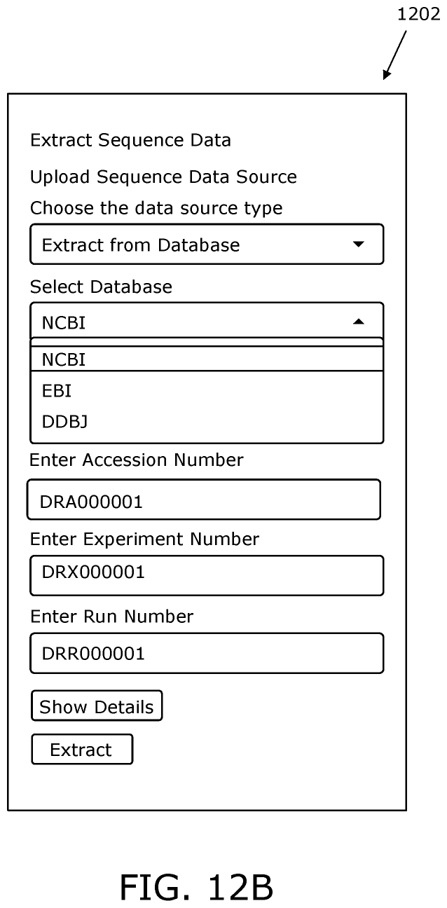

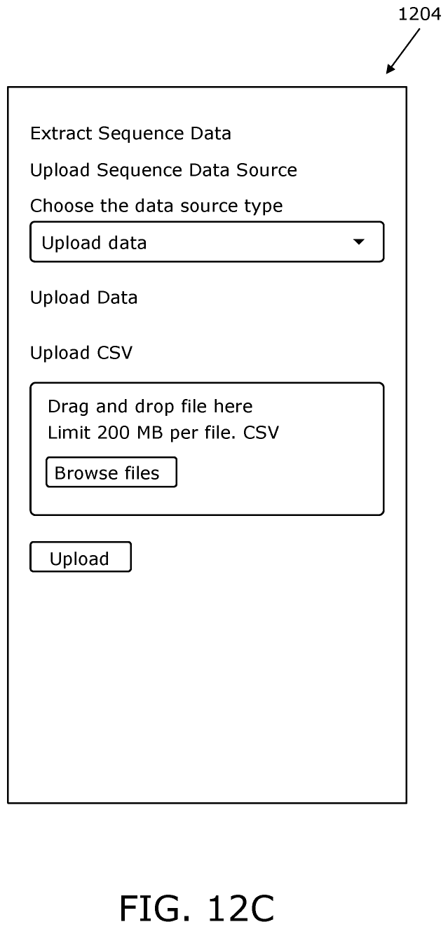

Referring to FIGS. 12A-12C collectively, shown are schematic illustrations of a graphical user interface 1200-1204 depicting various modes for data extraction 1104, in accordance with an embodiment of the present disclosure. During data extraction 1104, the users can extract data directly from a public database through the graphical user interface as depicted in FIGS. 12A-12B. In another embodiment, users can upload their experimental data directly by selecting, for example, one of European Bioinformatics Institute (EBI), DNA data bank of Japan (DDBJ), or National Centre for Biotechnology Information (NCBI) modes in a drop-down menu as depicted in FIG. 12B. The users are allowed to upload data by choosing a source and clicking on the “upload” tab as depicted in FIG. 12C.

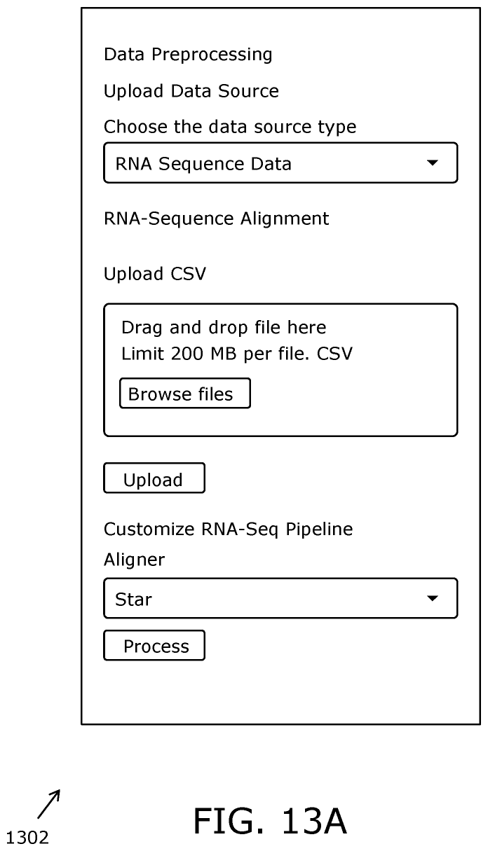

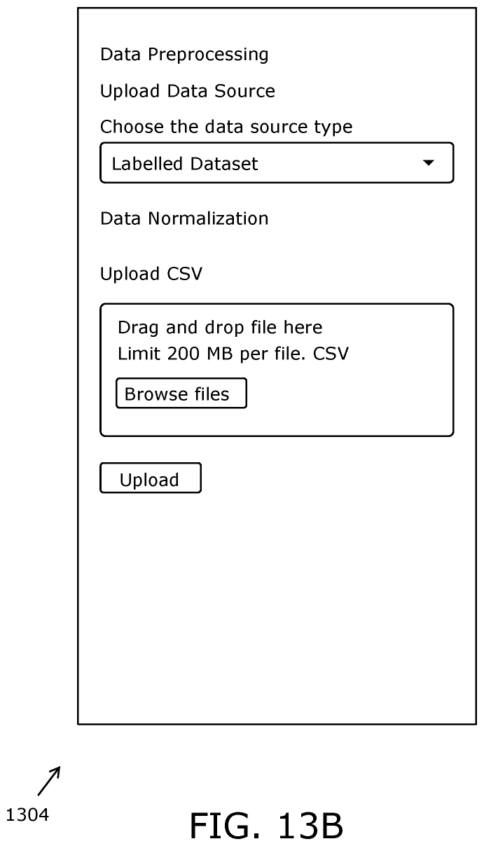

Referring to FIGS. 13A-13B, shown are schematic illustrations of exemplary graphical user interface views 1302-1304 during data pre-processing, in accordance with an embodiment of the present disclosure. During data pre-processing 1106, the sequence data is passed through quality check (QC), trimming, and quantification/alignment. The output data could be downloaded or used for modelling during subsequent stages.

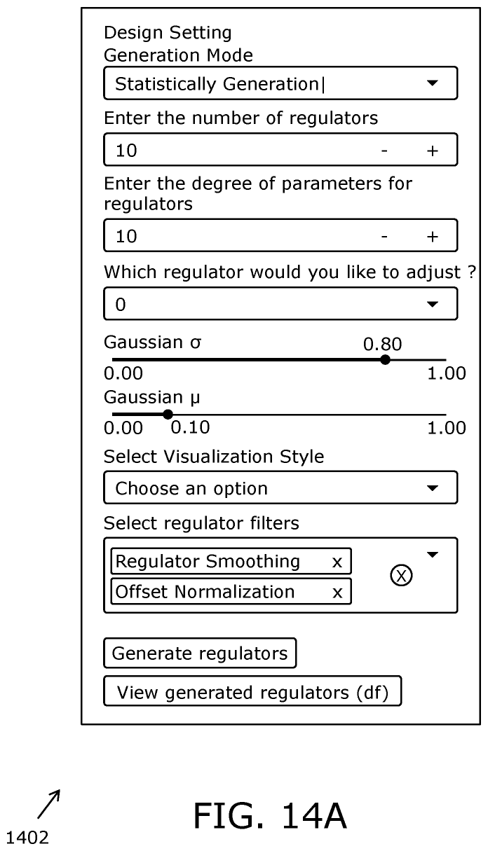

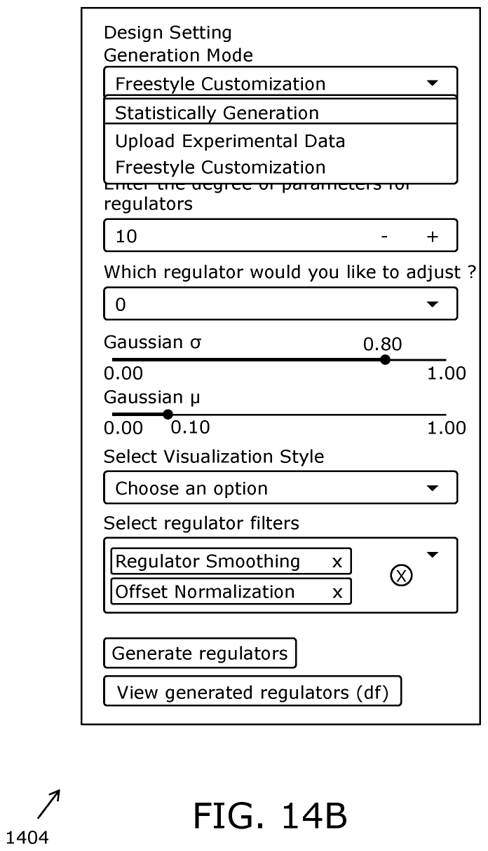

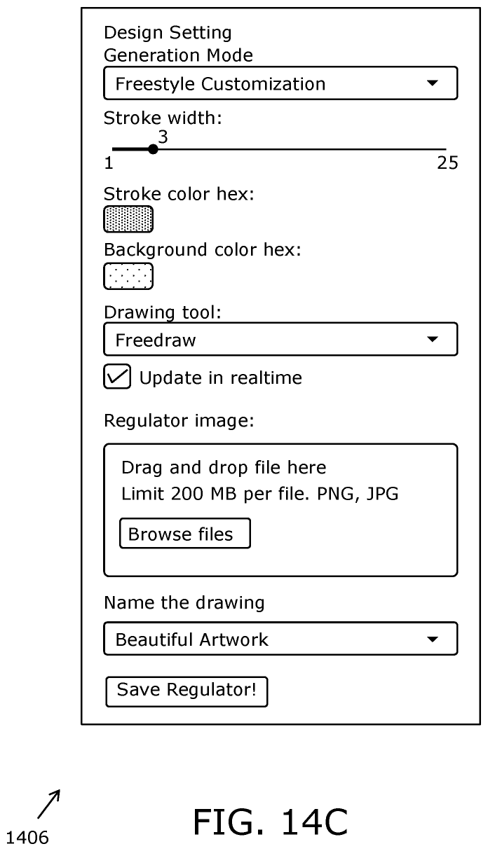

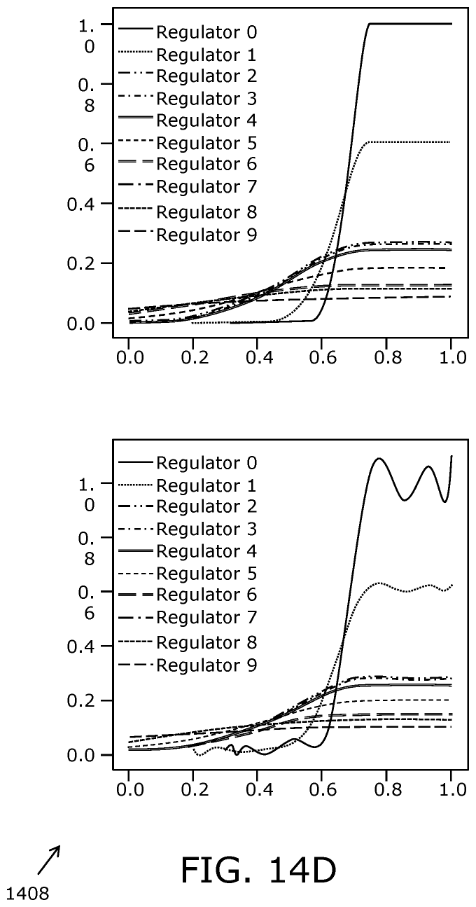

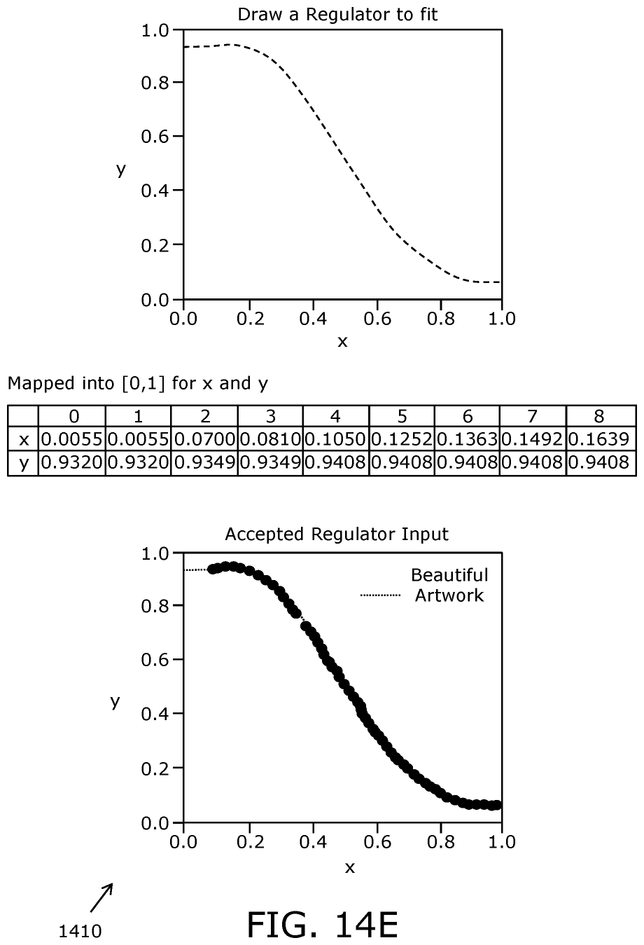

Referring to FIGS. 14A-14E collectively, shown are schematic illustrations of exemplary graphical user interface views 1402-1410 for generation of indications, in accordance with an embodiment of the present disclosure. In an embodiment, the indications are generated using gaussian distributions. In another embodiment, the indications are generated by directly uploading experimental results (i.e., Expression vs Concentration of stimulant). In yet another embodiment, the indications are generated by the user by freely drawing and dragging for adjustment of activation functions for exploration purposes, as depicted in FIG. 14C. FIG. 14D depicts exemplary graphs illustrating indications generated using gaussian distributions. FIG. 14E depicts exemplary graphs illustrating indications generated by freely drawing and dragging, in accordance with an exemplary scenario.

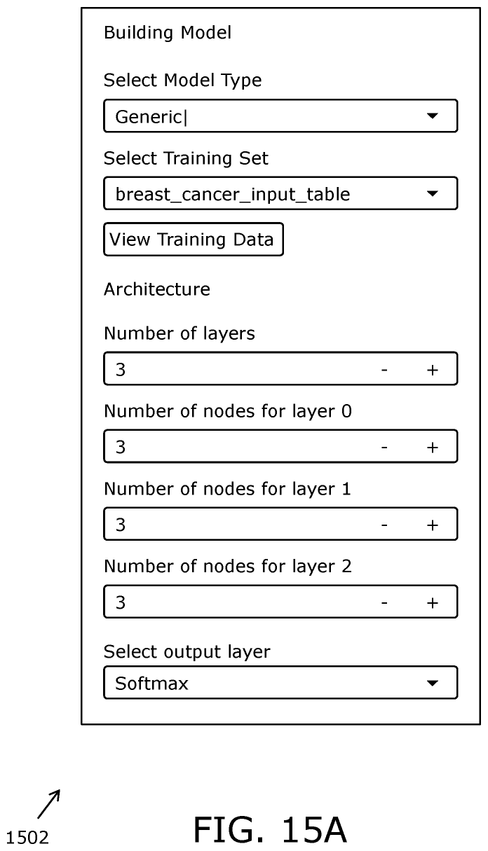

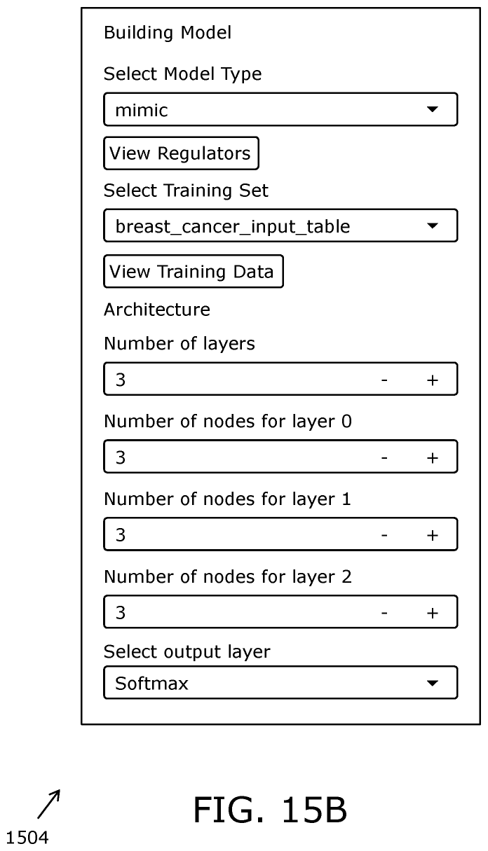

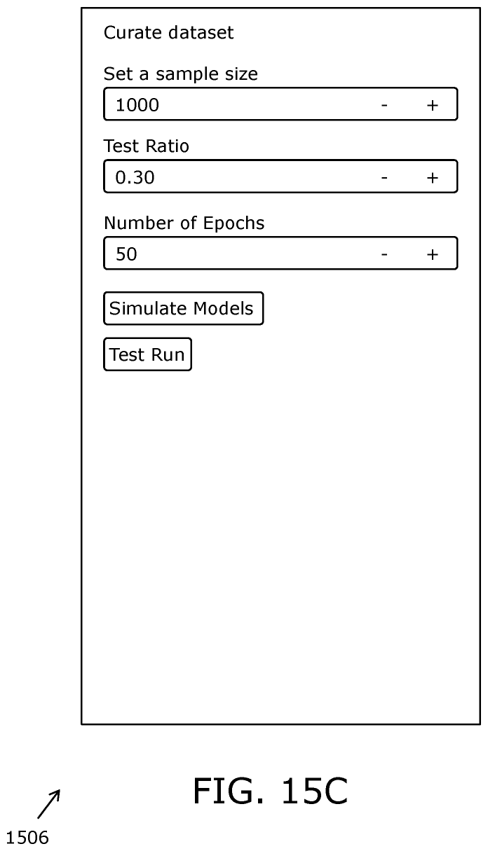

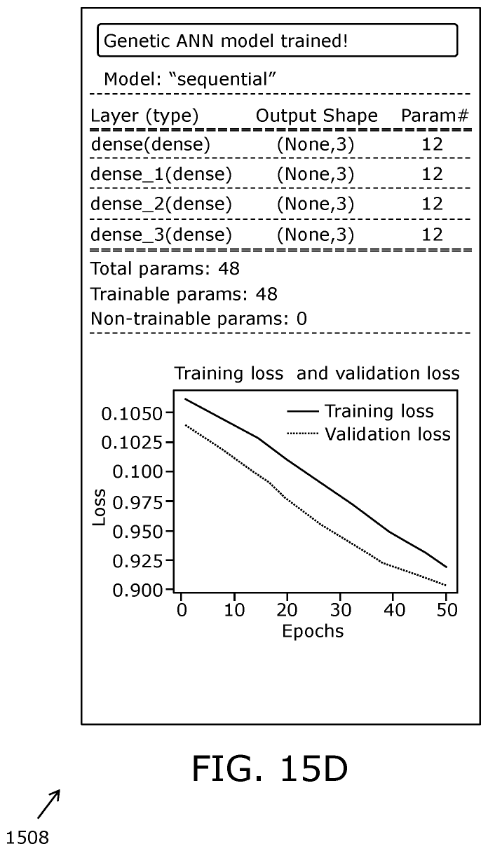

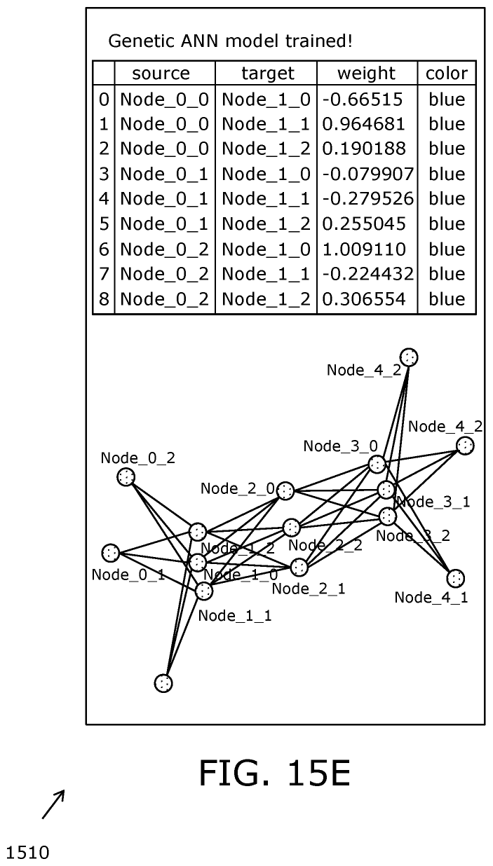

Referring to FIGS. 15A-15E collectively, shown are schematic illustrations of exemplary graphical user interface views 1502-1510 respectively for training the neural networks, in accordance with an embodiment. In an embodiment, the system 100 allows the user to select a set of indications to use for modelling via the graphical user interface. The user is allowed to choose the labelled dataset for running the model for the combination of indications that yield the highest likelihood for the labelled results. In an embodiment, the user can choose the model type, generic (ANN) or mimic (ANN), for comparison and experimentation benchmarking purposes. The mimic ANN has an extra selection of indication set. The number of layers and the number of nodes for each layer are totally flexible for both. The training set and the hold-out test set are separated at the beginning for fair test score. FIGS. 15D and 15E depict graphical user interface views 1508-1510 respectively corresponding to exemplary trained genetic ANNs, in accordance with an exemplary scenario.

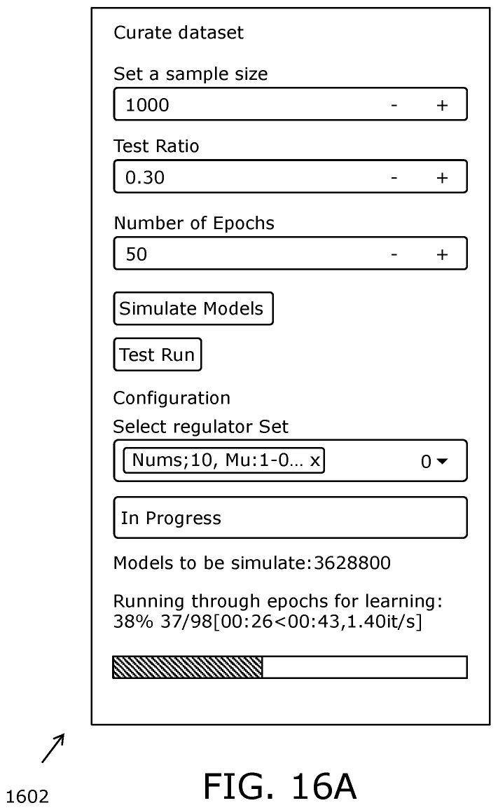

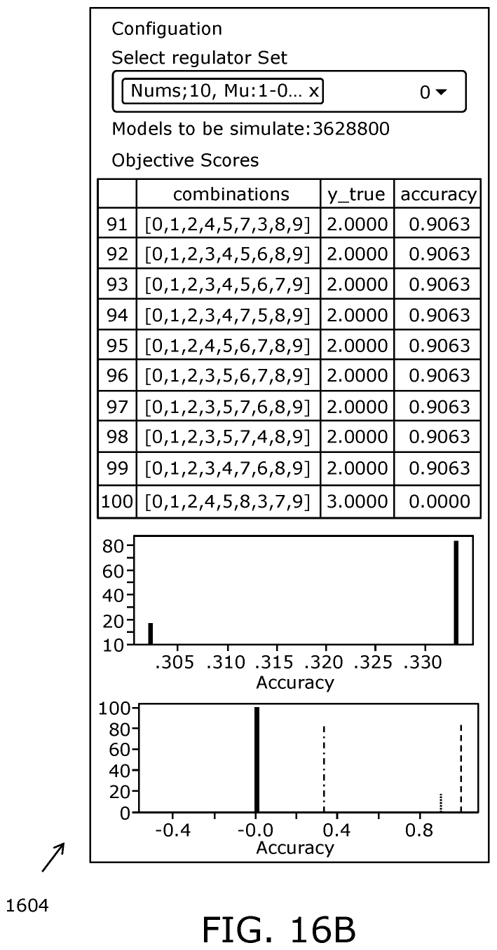

Referring to FIGS. 16A-16B collectively, shown are schematic illustrations of graphical user interface views 1602-1604 respectively for simulation of one or more indications associated with the one or more neural networks as a stochastic way for data prediction, in accordance with an exemplary scenario of the present disclosure. FIG. 16B depicts results 1604 of running generic ANN, in accordance with the exemplary scenario. The results include objective scores, and accuracy scores.

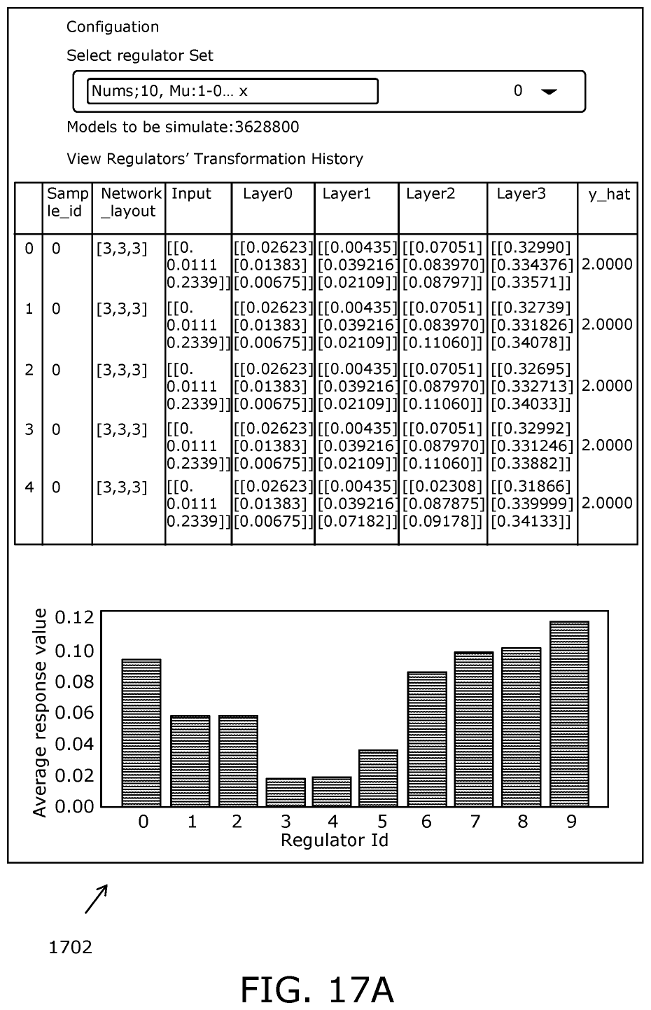

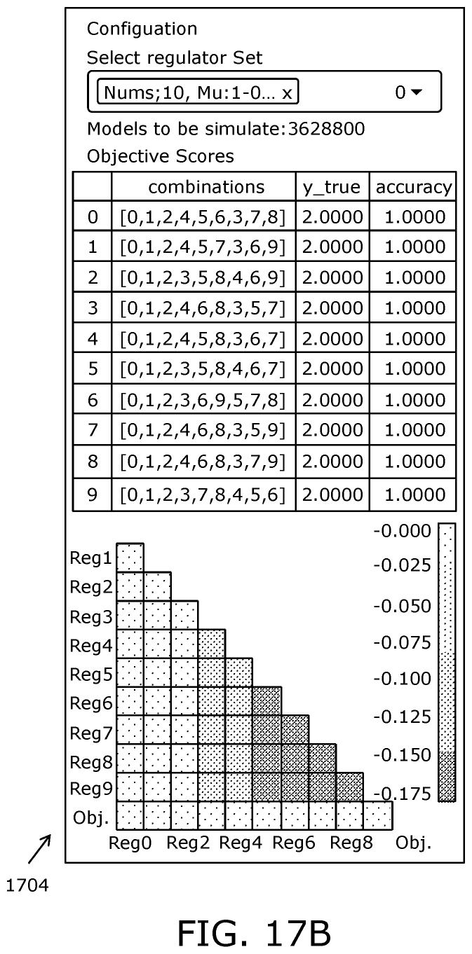

Referring to FIG. 17A, shown is a graphical user interface view 1702 of a transformation record of the indications, in accordance with an exemplary scenario of the present disclosure. Given a set of indication profiles, by propagating the input values from input to the output of the ANN with the user-defined indication profiles as activation functions, the transformation record of the indications can be used to understand the role of each indication binding site in the activation processes, in accordance with an embodiment.

Referring to FIG. 17B, shown is a graphical user interface view 1704 of biological indication profiles and the correlation between indications, in accordance with an exemplary scenario of the present disclosure. By using the biological indication profiles, extracted from RNA alignment results, as the activation components for building the ANN, the correlation between indications as depicted in FIG. 17B can be determined. The correlation between indications, as shown in FIG. 17B, indicates the effects of changing the value of certain indications on other indications which provide insight on different biological effects, such as knockout, knockdown, or over-expression.

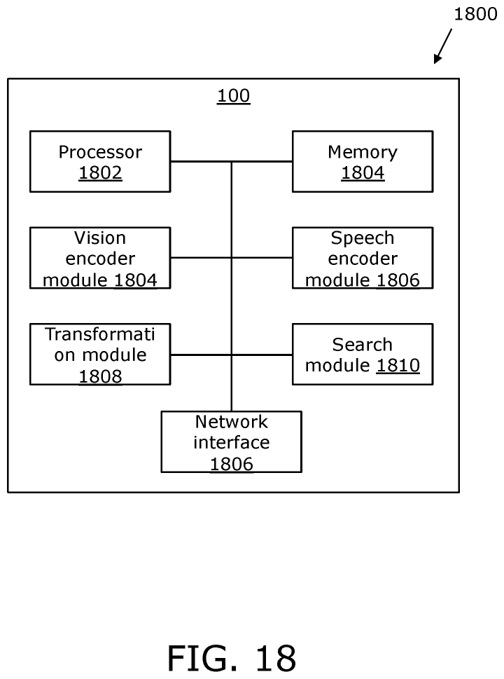

Referring to FIG. 18, shown is an example of a hardware implementation for system 100 of FIG. 1, in accordance with an embodiment of the present disclosure. With reference to FIG. 18, there is shown a block diagram 1800 that includes the system 100. The system 100 further includes a processor 1802, a memory 1804 and a network interface 1806, a vision encoder module 1804, a speech encoder module 1806, a transformation module 1808, a search module 1810.

The vision encoder module 1804 is configured to receive an image input, process the image input, and generate an output. In an embodiment, the vision encoder module 1804 is implemented as a vision encoder circuit. The speech encoder module 1806 is configured to receive a speech input, process the speech input and generate the output. In an embodiment, the speech encoder module 1806 is implemented as a speech encoder circuit. The transformation module 1808 is configured to transform the received structured visual representation. In an embodiment, the transformation module 1808 is implemented as a transformation circuit. The search module 1810 is configured to receive an image-based input, generate an image search query based on the input and generate at least one image-based output. In an embodiment, the search module 1810 is implemented as a search module circuit.

The processor 1802 refers to a computational element that is configured to respond to and process instructions that drive the system 100. The processor 1802 may cause the vision encoder module 1804, the speech encoder module 1806, the transformation module 1808 and the search module 1810 to perform their respective functions as described. In operation, the processor 1802 is configured to perform all the operations of the computing device 1802. Examples of implementation of the processor 1802 may include, but are not limited to, a central processing unit (CPU), a microprocessor, a microcontroller, a complex instruction set computing (CISC) microprocessor, a reduced instruction set (RISC) microprocessor, a very long instruction word (VLIW) microprocessor, or any other type of processing circuit. Furthermore, the processor 1802 may refer to one or more individual processors, processing devices and various elements associated with a processing device that may be shared by other processing devices.

The memory 1804 refers to a storage medium, in which the data or software may be stored. For example, the memory 1804 may store the instructions that drive the computing device. Examples of implementation of the memory 1804 may include, but are not limited to, Electrically Erasable Programmable Read-Only Memory (EEPROM), Read Only Memory (ROM), Hard Disk Drive (HDD), Solid-State Drive (SSD), and/or CPU cache memory.

The network interface 1806 includes suitable logic, circuitry, and interfaces that may be configured to communicate with one or more external devices, such as a server or another computing device. Example of the network interface 1806 may include, but are not limited to, an antenna, a network interface card (NIC), a transceiver, one or more amplifiers, one or more oscillators, a digital signal processor, and/or a coder-decoder (CODEC) chipset.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1.-25. (canceled)

26. A system arranged to customize an Artificial Neural Network (ANN) comprising:
an ANN architecture, comprising:
an input layer comprising at least one node, at least one hidden layer comprising at least one node, and an output layer comprising at least one node, wherein the input layer and the at least one hidden layer are connected by edges, and the at least one hidden layer and the output layer are connected by edges, wherein each node comprises an activation function;
a graphical user interface arranged to receive user input, the user input comprising:
indication on how to customize the number of hidden layers;
indication on how to customize the number of nodes for each of the hidden layers;
indication on how to customize at least one activation function for one or more of the nodes; and
a processor configured to:
provide the ANN based on the received indications of customization; and
simulate the ANN with a dataset, wherein the output of the simulation defines a measure of a benchmark of the ANN.

27. A system of claim 26, wherein the activation function of the input layer differs from the activation function of the at least one hidden layer, and/or the activation function of the at least one hidden layer differs from the activation function of the output layer, and/or the activation function of the input layer differs from the activation function of the output layer.

28. A system of claim 26, wherein the activation function of the input layer, the activation function of the at least one hidden layer, and the activation function of the output layer are all different.

29. A system of claim 26, wherein the activation function of a first node in the at least one hidden layer differs from the activation function of a second node in the at least one hidden layer.

30. A system of claim 26, wherein the processor is further configured to generate at least one activation function based on the dataset.

31. A system of claim 26, wherein the user input further comprises an indication of an estimation of an activation function, and the processor is further configured to generate the at least one activation function based on a transformation of the estimation.

32. A system of claim 26, wherein the at least one activation function is a gaussian function, sigmoidal function, reLu function, tanh function, a rectified linear function, or a swish function.

33. A system of claim 26, wherein the user input further comprises an indication on how to customize a weight of at least one of the edges.

34. A system of claim 26, wherein the processor is further configured to pre-process the dataset prior to simulating the ANN.

35. A system of claim 26, wherein the graphical user interface is arranged to receive additional user input of the pre-trained ANN, the additional user input comprising the data of the architecture of the ANN, comprising:
at least one activation function, the number of hidden layers, the number of nodes for each of the hidden layers; and/or the weight of all nodes.

36. A system of claim 26, further comprising a database configured to store at least one of:
the dataset, the number of layers, the number of nodes, the weight of the edges, the at least one activation function, the ANN, at least one layer of the ANN, the output of the run.

37. A system of claim 26, wherein the dataset corresponds to the measurement of at least one biological interaction.

38. A method arranged to customize an Artificial Neural Network (ANN), comprising:
providing an ANN architecture, comprising:
an input layer comprising at least one node, at least one hidden layer comprising at least one node, and an output layer comprising at least one node, wherein the input layer and the at least one hidden layer are connected by edges, and the at least one hidden layer and the output layer are connected by edges, wherein each node comprises an activation function;
providing a graphical user interface arranged to receive user input, the user input comprising:
indication on how to customize the number of hidden layers;
indication on how to customize the number of nodes for each of the hidden layers;
indication on how to customize at least one activation function for one or more of the nodes; and
providing a processor configured to:
provide the ANN based on the received indications of customization; and
simulate the ANN with a dataset, wherein the output of the simulation defines a measure of a benchmark of the ANN.

39. A method of claim 38, wherein the activation function of the input layer differs from the activation function of the at least one hidden layer, and/or the activation function of the at least one hidden layer differs from the activation function of the output layer, and/or the activation function of the input layer differs from the activation function of the output layer.

40. A method of claim 38, wherein the activation function of the input layer, the activation function of the at least one hidden layer, and the activation function of the output layer are all different.

41. A method of claim 38, wherein the activation function of a first node in the at least one hidden layer differs from the activation function of a second node in the at least one hidden layer.

42. A method of claim 38, wherein the processor is further configured to generate at least one activation function based on the dataset.

43. A method of claim 38, wherein the user input further comprises an indication of an estimation of an activation function, and the processor is further configured to generate at least one of the activation functions based on a transformation of the estimation.

44. A method of claim 38, wherein the at least one activation function is a gaussian function, sigmoidal function, reLu function, tanh function, a rectified linear function, or a swish function.

45. A computer program comprising instructions which, when the program is executed by a computer, cause the computer to carry out the steps of the method of claim 38.
